(19) United States
(12) Patent Application Publication
(10) Pub. No.: US 2011/0202998 A1
(43) Pub. Date: Aug. 18, 2011

(54) Method and System for Recognizing Malware

(75) Inventor: Thomas Dullien, Bochum (DE)

(73) Assignee: ZYNAMICS GMBH, Bochum (DE)

(21) Appl. No.: 13/030,404

(22) Filed: Feb. 18, 2011

(30) Foreign Application Priority Data
Feb. 18, 2010 (DE) 102010008538.3

(51) Int. Cl. G06F 21/00

(52) U.S. Cl. 726/24

(57) ABSTRACT

The invention relates to a method for recognizing a piece of malware in a computer memory system, comprising the steps of: providing a master signature comprising a number of byte sequences, producing at least one first signature element, said first signature element comprising a subset of the number of byte sequences in the master signature, and applying the first signature element to data stored in the computer memory system in order to recognize a piece of malware stored in the computer memory system.

### REFERENCE TO RELATED APPLICATIONS

This application is related to German Patent Application No. 10 2010 008 538.3-53 filed on Feb. 18, 2010 entitled “Method and System for Recognizing Malware”, hereby incorporated by reference in its entirety.

### FIELD OF THE INVENTION

The invention relates to a method for recognizing a piece of malware in a computer memory system and to a system for recognizing a piece of malware in a remote computer memory system.

### BACKGROUND

Malware, such as what are known as computer viruses, computer worms, Trojan horses, spyware or other software which is undesirable to the operator of the computer system, is a considerable financial and technical problem for modern computer networks. Normally, malware is stored in a computer memory system associated with a computer system by third parties individually or automatically, without the knowledge and volition of the operator of the computer system, in order to be executed permanently or at a particular opportunity on the computer system. The computer memory system may be any form of volatile or nonvolatile memory, particularly main memory (particularly random access computer memory, or RAM), hard disk memory, floppy disks, CD-ROMs, DVD-ROMs or the like. In this case, the malware is usually designed such that it cannot readily be recognized as such by the operator. In order to recognize malware in a computer memory system and possibly to remove it or render it harmless, what is known as antivirus software is regularly used. Normally, a piece of antivirus software is designed such that not only computer viruses in the narrower sense but also all kinds of malware, such as computer worms, Trojan horses, spyware, etc., are recognized.

Malware is generally not known in a source text written in high-level language, but rather is known only in a machine code which can be executed directly by a microprocessor. In order to recognize the malware in a computer memory system, antivirus software types which are known from practice involve every known machine code for a piece of malware having a byte sequence, known as the virus signature, generated for it, said byte sequence characterizing said machine code. The virus signature comprises sufficient information to allow the antivirus software to decide, when examining a computer memory system, whether or not a particular stored data section is the known machine code, associated with the virus signature, for a piece of malware. The virus signature is generated by the manufacturer of the antivirus software on a central computer system. Next, the generated virus signature is transmitted by internet to remote computer systems of the users, on which the antivirus software is installed locally, in order to allow the malware to be recognized in the local computer memory system. The problem is that the recognition of the malware is based only on recognition of the known machine code. This is exploited by programmers of malware, to whom the source text of the malware program is accessible, in order to bypass the antivirus software: the machine code of the malware is modified by the programmers of the malware such that the malware is no longer recognized by the antivirus software by means of the known virus signature. This is frequently possible without functional changes and without or only with minor changes of the source text of the malware, for example simply as a result of fresh translation of the source text into further executable machine code using different compiler options. In this context, the programmer of the malware can use the virus signature provided by the manufacturer to easily check whether or not the further executable machine code of the malware is recognized by the antivirus software. New versions of the executable machine code can be generated with relatively little effort until a version of the machine code which is not recognized by the antivirus software has been produced. In this way, the programmers of malware gain a time advantage over the manufacturers of the antivirus software, since the freshly generated machine code of the malware is not recognized by the antivirus software until a new, corresponding virus signature is produced and distributed. A further problem is that the number of virus signatures increases further with every new version of the machine code for a piece of inherently known malware. Since the virus signatures are transmitted by the manufacturers of the antivirus software from a central computer system by Internet to the large number of remote computer systems of the users, the bandwidth required for transmitting the virus signatures and the requisite memory space on the local computer systems of the users for the virus signatures increase continually, which accordingly results in increasing costs.

The sum total of different machine codes which each form executable versions of a piece of at least functionally largely identical maiware is subsequently called a family of malware.

The document “Automatisierte Signaturgenerierung für Malware-Stämme” [Automated signature generation for malware strains] by Christian Blichmann, Thesis, Chair of Information Science VI, Dortmund technical University, Jun. 3, 2008, describes a method for creating what is known as a master signature, which can be used to reliably recognize different machine codes in a malware family using only a single master signature. The master signature is generated by means of the following steps: first of all, an abstract representation of the executable machine code of the malware is obtained by means of disassembly, i.e. back-translation from the executable machine code into a machine-level assembly language. Analysis of jump instructions results in information about functional relationships for the malware. Next, these steps are applied to further versions of executable machine code which are assumed to be members of the same maiware family. Pair comparison of the abstract representations produced is used to detect structural properties which are contained in every member of the malware. Structural properties which are present identically in all known members of the malware family are detected and stored as information in the master signature. In this way, just one master signature can be used to recognize all known versions of executable machine code for a malware family. Furthermore, previously unknown members of the malware family can likewise be detected by means of the master signature, so long as the unknown members of the malware family continue to have all the structural properties which are stored in the master signature. Instead of a large number of virus signatures for a malware family, it is therefore sufficient for only the master signature to be provided for the purpose of recognizing malware. A drawback is that distribution of the master signature to the antivirus software means that it continues to be possible for the programmers of malware to generate new modifications of the machine code for the malware in a relatively simple manner by trial and error by modifying the machine code or the source text of the malware until a variant of the machine code which can certainly not be detected by the antivirus software and the master signature has been generated. The time advantage of the programmers of the malware over the manufacturers of the antivirus software is thus preserved.

### SUMMARY OF THE INVENTION

It is an object of the invention to specify a method for recognizing a piece of malware in a computer memory system which allows reliable recognition of malware.

It is a further object of the invention to specify a system for recognizing a piece of malware in a remote computer memory system which allows reliable recognition of malware and which does not permit reliable bypassing by virtue of the generation of previously unknown machine codes.

These and other objects of the invention are achieved by a method for recognizing malware in a computer memory system, comprising the steps of: providing a master signature comprising a number of byte sequences, producing at least one first signature element, said first signature element comprising a subset of the number of byte sequences in the master signature, and applying the first signature element to data stored in the computer memory system in order to recognize a piece of malware stored in the computer memory system.

These and other objects of the invention are further achieved by a system for recognizing malware in remote computer memory systems, comprising a master signature comprising a number of byte sequences, a central computer system, and at least one first remote computer memory system, wherein a group of signature elements is provided in the central computer system, wherein each of the signature elements comprises an individual subset of the number of byte sequences in the master signature, wherein at least one first signature element from the group of signature elements is transmittable from the central computer system to the first remote computer memory system and is exercisable to data stored in the first computer memory system in order to recognize a piece of malware stored in the first computer memory system.

These and other objects of the invention are still further achieved by a method for providing signatures for malware identification purposes, comprising the steps of providing at least one master signature comprising a number of byte sequences, said master signature being useful for identification of at least one piece of malware, generating at least one identifying signature, wherein said identifying signature comprises a subset of the number of byte sequences, and providing said identifying signature for malware identification purposes.

The method for recognizing a piece of malware in a computer memory system comprises the following steps: a master signature comprising a number of byte sequences is provided, at least one first signature element, which comprises a subset of the number of byte sequences in the master signature, is produced, and the first signature element is applied to data stored in the computer memory system in order to recognize a piece of malware which is stored in the computer memory system. In the present case, a byte sequence is understood to mean an ordered series of computer-readable data in the form of bytes. A byte as an established storage unit in computer systems can be represented in the form of a two-digital hexadecimal number, for example. It has to be understood that a byte sequence can be converted into another representation, for example into a bit sequence, by means of mathematical transformation with constant information content. It also hast to be understood that in computer systems with a relatively large native storage unit (for example 16, 32 or 64 bits) it is possible for said storage unit to be used for representing the master signature, in which case the master signature comprises an ordered sequence of computer-readable data in the form of said storage units. Each byte sequence in the master signature comprises data which are associated with a data section which is contained in every known machine code in the malware family. Since all the byte sequences in the master signature have data equivalents in every member of the malware family, all the byte sequences of a signature element of the master signature also have data equivalents in all members of the malware family. Accordingly, any signature element can be used to recognize each of the known family members of the malware family. The provision and application of only one signature element of the master signature for the recognition of malware in a computer memory system now provide the advantage that known members of the malware family continue to be safely recognized. For a programmer of the malware, however, the signature element can no longer be used to reliably assess whether or not a machine code that he has altered continues to be recognized by the antivirus software. The altered machine code is no longer recognized by the antivirus software by means of the signature element at precisely the time at which at least one of the byte sequences in the signature element has no further equivalence in the altered machine code. The programmer of the malware therefore knows with certainty for the known signature element whether or not the altered machine code is recognized by the antivirus software. Other signature elements of the master signature do not comprise the very byte sequence in question, however, and will therefore (provided that no other byte sequence is affected) continue to make the altered machine code reliably recognizable. Without complete knowledge of the master code and without changing the machine code for each byte sequence of the master code, it is therefore impossible for the programmer of the malware to bypass the antivirus software reliably. Use of subsequences therefore at least significantly complicates the previously possible relatively simple bypassing of antivirus software.

Expediently, the master signature is designed such that the byte sequences store data in an organized order which are also found in this order in a memory section that contains malware in an afflicted computer memory system. By comparing the data contained in the memory section of the computer memory system with the data contained in a master signature, it is thus possible to recognize the malware. Preferably, the master signature is designed such that it also comprises position information for the data in addition to the data in the form of byte sequences that are characteristic of the malware. In one advantageous arrangement, the position information is in the form of a byte arranged between adjacent byte sequences that represents a wildcard character. The wildcard character indicates that arbitrary data in a particular or arbitrary length may be arranged in the machine code of the malware between the data which correspond to the byte sequences adjacent to the wildcard character. It has to be understood that a wildcard character can also be used to mean that only particular data, arbitrary data of particular length or with a particular minimum or maximum length or a combination thereof may be arranged at the position of the wildcard character. It also has to be understood that it is possible to use different wildcard characters which each have a different meaning, for example an arbitrary or restricted volume of data, or a data sequence of arbitrary or restricted length. The master signature can thus advantageously be represented as a series of byte sequences spaced apart by wildcard characters. This design of the master signature allows the characteristic data of a malware family to be stored reliably and flexibly.

It is known from practice that some malware programs comprise a machine code with an immediately executable portion and an encrypted portion which cannot be executed immediately. The encryption may have been chosen such that every call to the malware involves a new key being required and generated for decryption, so that the encrypted portion of the malware program is always stored in its encrypted form in the computer memory in altered fashion. In this form, the encrypted portion is not available for recognition by means of a signature. In order nevertheless to allow reliable recognition of the malware program, the malware program is started in a protected computer memory section of the affected computer system in order to achieve decryption, at the same time ensuring that the malware cannot deploy its defective action. The thus decrypted form of the machine code is used for generating the master signature.

Advantageously, the arrangement of the byte sequences in the master signature defines a rising order, with the byte sequences of the signature element expediently being arranged so as to rise in the thus defined order. The order of the byte sequences in any signature element thus continues to correspond to the order in which the associated data are also arranged in the respective machine code of the malware. Every signature element is distinguished from the master signature essentially in that individual byte sequences are omitted but the order of the remaining byte sequences is unaltered.

Preferably, the method also comprises the step of applying a further signature to data stored in the computer memory system which have been recognized as data from a piece of malware. Since the first signature element has a reduced number of byte sequences in comparison with the master signature, there is an increased risk—in comparison with use of the master signature—that a harmless piece of useful software is wrongly recognized as malware by virtue of random equivalence of data areas with the byte sequences of the signature element. The risk of incorrect recognition of a piece of useful software as malware is reduced by virtue of a further check with an initial signature.

Preferably, the further signature is a second signature element, wherein the second signature element comprises a subset of the number of byte sequences in the master signature. This allows a reduction in the risk of a piece of useful software being wrongly recognized as malware without the need for the entire master signature to be revealed. Expediently, the second signature element comprises at least one byte sequence which is not contained in the first signature element.

Additionally or alternatively, the further signature is a positive signature for recognizing a piece of useful software which has incorrectly been recognized as harmful. Particularly if the potential incorrect recognition of a piece of useful software by means of signature elements or even by means of the master signature is known, the creation of a positive signature which allows the useful software to be reliably distinguished from the malware allows incorrect recognition of the useful software as malware to be reliably prevented.

The system for recognizing a piece of malware in remote computer memory systems comprises a master signature comprising a number of byte sequences, a central computer system, and at least one first remote computer memory system, wherein a group of signature elements is provided in the central computer system, each of the signature elements comprising an individual subset of the number of byte sequences in the master signature, and at least one first signature element from the group of signature elements being able to be transmitted from the central computer system to the first remote computer memory system and being able to be applied to data stored in the first computer memory system in order to recognize a piece of malware stored in the first computer memory system. As explained above, the provision and application of only one signature element for the master signature advantageously allows known members of the malware family to be reliably recognized. Similarly, previously unknown members of the malware family are recognized by means of the signature element if they continue to have the characteristic data detected in the signature element. However, a programmer of the malware cannot use the provided signature element to reliably assess whether or not a machine code that he has altered is recognized by the antivirus software when different signature elements are used.

Preferably, the first signature element is selected from the group of signature elements on the basis of a criterion, wherein the criterion comprises at least one element from: time of the transmission to the first computer memory system, time of a transmission request by the first computer memory system to the central computer system, association of the first computer memory system with a predefined user group, and random selection. Selection of the signature element on the basis of the time of the transmission or transmission request to the central computer system allows distribution of different signature elements to be achieved in a targeted manner. For the programmers of malware, the distribution of different signature elements increases the probability of a freshly created member of a malware family being quickly recognized and taken into account in future signatures as a result of the antivirus software reporting back to the central computer system. Target selection of the signature element which is to be transmitted on the basis of the association of the first computer memory system with a predefined user group, and also partial or complete random selection, results in targeted distribution of different signature elements.

Preferably, the system comprises at least one second remote computer memory system, wherein at least one second signature element from the group of signature elements can be transmitted from the central computer system to the second remote computer memory system, and wherein the first signature element and the second signature element differ from one another.

Advantageously, expiry of a prescribed period is followed by the first signature element being replaced by virtue of the transmission of a different third signature element to the first remote computer memory system. Replacing the signature elements with further signature elements encourages real-time recognition of new members of a malware family and further increases the uncertainty for programmers of malware, since a new member of the malware family which apparently cannot be recognized by the antivirus software is exposed to a higher risk of recognition after a relatively short time. The distribution of different signature elements in the course of time or to different user groups also makes it much more difficult for the authors of the malware to fully compile the signature elements with the aim of portraying the master signature.

Expediently, the system comprises a plurality of master signatures, wherein an associated group of signature elements is provided for each master signature. In this context, each of the master signatures is expediently associated with a separate malware family.

Further advantages and features of the invention can be found in the description of an exemplary embodiment of the invention which follows.

The invention is explained below using an exemplary embodiment with reference to the appended figures.

### BRIEF DESCRIPTION OF THE DRAWINGS

FIG. 1 schematically shows a memory map of the machine code of two malware programs associated with a malware family, virus signatures associated with the respective malware programs, the master signature associated with the malware family and signature elements derived from the master signature.

### DETAILED DESCRIPTION

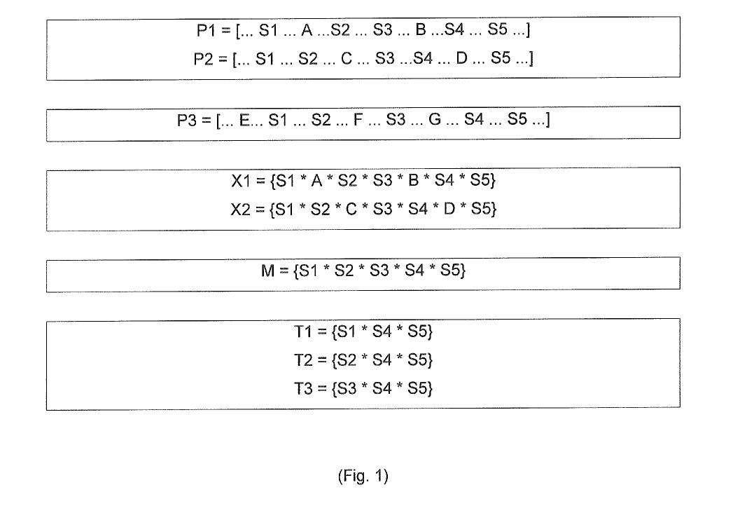

The top area of FIG. 1 shows a schematic illustration of the memory map of the machine code—which can be executed directly by a computer system—for two malware programs P1, P2. Each memory map comprises a series of bytes which respectively store data and instructions which altogether make up the machine code of the respective malware program P1, P2. In the illustration, “ . . . ” signifies a succession of bytes which is not characteristic of the malware program, i.e. this succession of bytes is respectively not suitable for individually distinguishing the malware program from other machine code which is associated with other useful programs or malware programs. The symbols “S1”, “S2”, “S3”, “S4”, “S5”, “A” and “B” represent characteristic byte sequences for the first malware program P1. These byte sequences are each suitable for distinguishing the machine code of the malware program P1 from the machine code of other useful programs or malware programs. The symbols “S1”, “S2”, “S3”, “S4”, “S5”, “C” and “D” represent characteristic byte sequences for the second malware program P2. As can be seen, the first malware program P1 and the second malware program P2 have the characteristic byte sequences “S1”, “S2”, “S3”, “S4”, “S5” in common.

FIG. 1 schematically shows virus signatures X1, X2 beneath the memory maps of the malware programs P1, P2. The first virus signature X1 is associated with the first malware program P1, and the second virus signature X2 is associated with the second malware program P2. As can be seen, the first virus signature X1 comprises the characteristic byte sequences “S1”, “A”, “S2”, “S3”, “B”, “S4”, “S5” of the first malware program in the order which arises in the first malware program. The byte sequences are each separated by the wildcard character “*” in the virus signature. This means that when the virus signature is compared with the memory map of an arbitrary memory section, any succession of bytes can be arranged at the position of the wildcard character “*”. Similarly, the second virus signature X2 comprises the characteristic byte sequences “S1”, “S2”, “C”, “S3”, “S4”, “D”, “S5” of the second malware program in the order which arises in the second malware program. As can be seen, the first virus signature X1 is suitable, as a result of comparison with the memory map of the first malware program P1, for identifying the first malware program P1. By contrast, recognition of the second malware program P2 using the first virus signature X1 is not possible, since the byte sequences “A” and “B” which are necessary for positive recognition are not contained in the memory map of the second malware program P2. Similarly, the second virus signature X2 can be used to recognize the second malware program P2 but not the first malware program P1.

The master signature M as shown in FIG. 1 has been produced by determining the characteristic byte sequences which are contained in common in P1 and P2. As can be seen, the master signature M comprises the byte sequences “S1”, “S2”, “S3”, “S4” and “S5”, which are respectively connected to one another by a wildcard “*”. By virtue of comparison with the memory maps of the malware programs P1 and P2, it is possible to see that the master signature M is suitable for recognizing the malware programs P1 and P2 as malware in each case.

FIG. 1 also shows the memory map of a further, third malware program P3 associated with the malware program family. The machine code of the third malware program P3 has not been taken into account in the master signature M to date. As can be seen, the machine code of the third malware program P3 contains, in addition to the characteristic byte sequences “S1”, “S2”, “S3”, “S4”, “S5”, further characteristic byte sequences “E”, “F” and “G” which were previously not known from the first malware program P1 and the second malware program P2. However, comparison of the master signature M with the memory map of the third malware program P3 shows that the previously unknown malware program P3 is also reliably recognized, since all the characteristic byte sequences “S1”, “S2”, “S3”, “S4”, “S5” contained in the master signature M are also contained in the third malware program P3.

If the master signature M were used directly to recognize the malware programs P1, P2, P3, this would in each case result in reliable recognition of the malware programs. However, a drawback would be that the programmer of the malware would immediately be provided with a way of bypassing the antivirus software if he knows the master signature M as a result of modification of the malware programs such that at least one of the characteristic byte sequences “S1”, “S2”, “S3”, “S4”, “S5” is no longer contained in the memory map of the machine code. For this reason, the master signature M is used to produce signature elements which each contain a subset of the byte sequences in the master signature. FIG. 1 shows three signature elements T1, T2 and T3 by way of example. As can be seen, each of the signature elements T1, T2 and T3 is suitable for recognizing each of the malware programs P1, P2 and P3 reliably as malware. At the same time, if only two of the signature elements T1, T2, T3 or even only one of the signature elements T1, T2, T3 is/are known then it is not possible to infer the master signature M. Accordingly, use of signature elements can prevent the programmer of the malware from achieving reliable bypassing of the antivirus software by means of simple modification of the machine code of the malware.

A simplified exemplary embodiment of the invention has been explained by way of example above. When applied to actually existing malware programs, the master signature has a much greater number of byte sequences, which means that a correspondingly large number of signature elements can be formed. The master signature can thus be inferred from the signature elements only with a very high level of complexity and with great uncertainty.

What is claimed is:

1. A method for recognizing malware in a computer memory system, comprising the steps of:
providing a master signature comprising a number of byte sequences;
producing at least one first signature element, said first signature element comprising a subset of the number of byte sequences in the master signature; and
applying the first signature element to data stored in the computer memory system in order to recognize a piece of malware stored in the computer memory system.

2. The method as claimed in claim 1, wherein the arrangement of the byte sequences in the master signature defines a rising order, and wherein the byte sequences in the signature element are arranged in rising order.

3. The method as claimed in claim 1, comprising the step of applying a further signature to data stored in the computer memory system which have been recognized as data from a piece of malware.

4. The method as claimed in claim 3, wherein the further signature is a second signature element which comprises a subset of the number of byte sequences in the master signature.

5. The method as claimed in claim 3, wherein the further signature is a positive signature for recognizing a piece of useful software which has been incorrectly recognized as harmful.

6. A system for recognizing malware in remote computer memory systems, comprising:
a master signature comprising a number of byte sequences;
a central computer system; and
at least one first remote computer memory system;
wherein a group of signature elements is provided in the central computer system;
wherein each of the signature elements comprises an individual subset of the number of byte sequences in the master signature;
wherein at least one first signature element from the group of signature elements is transmittable from the central computer system to the first remote computer memory system and is exercisable to data stored in the first computer memory system in order to recognize a piece of malware stored in the first computer memory system.

7. The system as claimed in claim 6, wherein the first signature element is selected from the group of signature elements on the basis of a criterion, wherein the criterion comprises at least one element from the group comprising: time of the transmission to the first computer memory system, time of a transmission request by the first computer memory system to the central computer system, association of the first computer memory system with a predefined user group, and random selection.

8. The system as claimed in claim 6, further comprising at least one second remote computer memory system, wherein at least one second signature element from the group of signature elements can be transmitted from the central computer system to the second remote computer memory system, and wherein the first signature element and the second signature element differ from one another.

9. The system as claimed in claim 6, wherein expiry of a prescribed period is followed by the first signature element being replaced by virtue of the transmission of a different third signature element to the first remote computer memory system.

10. The system as claimed in claim 6, comprising a plurality of master signatures, wherein an associated group of signature elements is provided for each master signature.

11. A method for providing signatures for malware identification purposes, comprising the steps of:
providing at least one master signature comprising a number of byte sequences, said master signature being useful for identification of at least one piece of malware;
generating at least one identifying signature, wherein said identifying signature comprises a subset of the number of byte sequences; and
providing said identifying signature for malware identification purposes.
